(19) United States
(12) Patent Application Publication
(10) Pub. No.: US 2023/0064017 A1
(43) Pub. Date: Mar. 2, 2023

(54) REUSABLE E-INK PAPER

(71) Applicant: HEWLETT-PACKARD DEVELOPMENT COMPANY, L.P., Spring, TX (US)

(72) Inventors: Heungsup PARK, Seongnam-si, Gyeonggi-do (KR); Daniel Scott ELLIS, Seongnam-si, Gyeonggi-do (KR); Sungho KIM, Seongnam-si, Gyeonggi-do (KR); HongKwon LEE, Seongnam-si, Gyeonggi-do (KR); DoHyung KIM, Seongnam-si, Gyeonggi-do (KR)

(21) Appl. No.: 17/799,017

(22) PCT Filed: Feb. 19, 2021
(86) PCT No.: PCT/US2021/018662

§ 371 Date: Aug. 11, 2022

(30) Foreign Application Priority Data
Feb. 20, 2020 (KR) 10-2020-0020887

(51) Int. Cl. G02F 1/16753; G02F 1/167; B42D 25/333; B42D 25/36; C25D 13/12

(52) U.S. Cl. CPC G02F 1/16753; G02F 1/167; B42D 25/333; B42D 25/36; C25D 13/12; G02F 1/133528

(57) ABSTRACT

Electronic ink paper includes: an image display area comprising a support layer, a conductive layer on the support layer, an ink layer on the conductive layer and to display an image by electrophoresis of pigment particles dispersed in an electrophoretic liquid, and a transparent surface layer to cover the ink layer; and a border to surround the image display area and including at least one edge having a tapered shape that decreases in thickness toward the outside of the border.

### BACKGROUND

A printer prints an image on a printing medium by using a printing method such as an electrophotographic method or an inkjet method. Paper is generally used as a printing medium.

Attempts have been made to replace paper as a printing medium with other media. One of these media is an electrophoretic display that displays images in an electrophoretic manner. In an electrophoretic display, charged pigment particles dispersed in an electrophoretic liquid are moved to a front surface or a back surface in response to an external voltage. The electrophoretic display includes an ink layer containing pigment particles dispersed in an electrophoretic liquid, a substrate located below the ink layer and provided with a thin-film transistor array, and a common electrode provided on the ink layer. The common electrode includes a transparent conductive material. An image is displayed in the ink layer by moving the pigment particles toward the common electrode or toward the substrate according to a driving voltage applied to the thin-film transistor array.

This type of electrophoretic display is difficult to implement in a flexible form such as paper due to the substrate provided with the thin-film transistor array, and it is also difficult to keep the cost low enough to replace the use of paper.

### BRIEF DESCRIPTION OF THE DRAWINGS

FIG. 1 is a plan view of one example of electronic ink paper.

FIG. 2 is a cross-sectional view of one example of electronic ink paper.

FIG. 3 is a cross-sectional view of another example of electronic ink paper.

FIG. 4 is a schematic configuration diagram of an example of a printer using electronic ink paper.

FIG. 5 is a view illustrating a state in which plural pieces of electronic ink paper are loaded on a loading table in an example.

FIGS. 6 and 7 are views illustrating various examples of a tapered shape of a border.

FIGS. 8 and 9 are views illustrating various examples of a border.

FIG. 10 is a cross-sectional view of one example of electronic ink paper.

FIG. 11 is a plan view of one example of electronic ink paper.

FIG. 12 is a plan view of one example of electronic ink paper.

FIG. 13 is a plan view of one example of electronic ink paper.

### DETAILED DESCRIPTION

Hereinafter, examples of electronic ink (for example, E-ink) paper will be described with reference to the accompanying drawings. The same reference numerals refer to the same elements throughout. In the drawings, the sizes of constituent elements may be exaggerated for clarity.

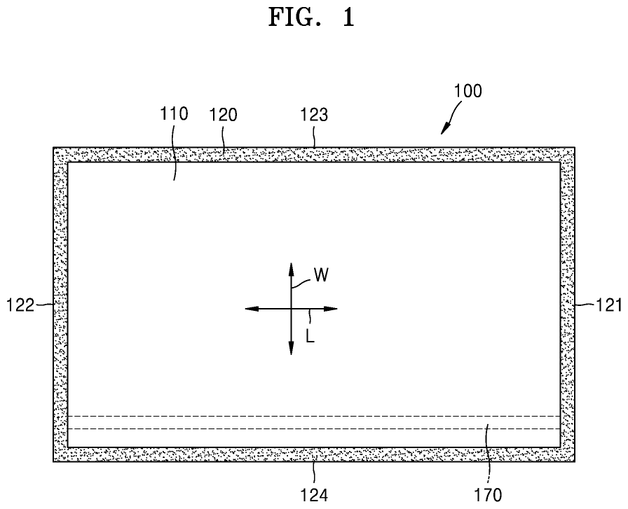

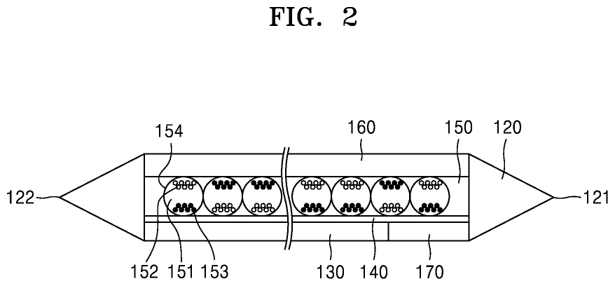

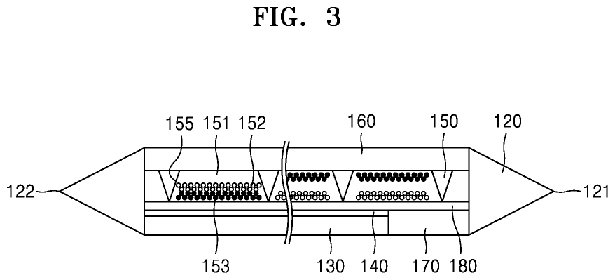

FIG. 1 is a plan view of one example of electronic ink paper 100. FIG. 2 is a cross-sectional view of one example of the electronic ink paper 100. FIG. 3 is a cross-sectional view of another example of the electronic ink paper 100.

Referring to FIGS. 1, 2, and 3, the electronic ink paper 100 includes an image display area 110 and a border 120. The image display area 110 includes a support layer 130, a conductive layer 140 provided on the support layer 130, an ink layer 150 located on the conductive layer 140 and displaying an image by electrophoresis of pigment particles dispersed in an electrophoretic liquid, and a transparent surface layer 160 covering the ink layer 150. The border 120 surrounds, partially or completely, the image display area 110. At least one edge of the border 120 has a shape that decreases in thickness toward the outside of the border 120. The edge of the border 120 may be connected to at least one of the surface layer 160 and the support layer 130.

The support layer 130 may be a flexible fibrous layer such as cellulose or pulp. The support layer 130 may be a flexible polymer material layer such as an acrylic compound, an amide compound, a phthalate compound, polypropylene, or polyethylene. For example, the support layer 130 may be an acrylic film, a polyimide (PI) film, a polyethylene terephthalate (PET) film, a polypropylene (PP) film, or a polyethylene (PE) film. The support layer 130 may be an opaque layer or a transparent layer.

The conductive layer 140 is provided on the support layer 130. The conductive layer 140 may be, for example, an opaque conductive material layer or a transparent conductive material layer. By forming the conductive layer 140 with a conductive material, such as an opaque conductive material, that is less expensive than another conductive material, such as a transparent conductive material, the cost of the electronic ink paper 100 may be reduced.

The surface layer 160 covers the ink layer 150. The surface layer 160 is a flexible transparent layer through which light may pass, and an image displayed on the ink layer 150 may be observed through the surface layer 160. The surface layer 160 may be, for example, a transparent and flexible polymer material layer such as an acrylic compound, an amide compound, a phthalate compound, polypropylene, or polyethylene. For example, the surface layer 130 may be an acrylic film, a PI film, a PET film, a PP film, or a PE film.

The ink layer 150 is arranged on the conductive layer 140 and displays an image by electrophoresis. The ink layer 150 may be adhered to the conductive layer 140 by an adhesive material (not shown). The ink layer 150 may include an electrophoretic liquid 151 and charged pigment particles 152 and 153 dispersed inside the electrophoretic liquid 151. The electrophoretic liquid 151 may be transparent and may have a color. For example, when displaying a black and white image, the pigment particles 152 may be white particles, and the pigment particles 153 may be black particles. The white particles 152 and the black particles 153 may be particles having different electric charges. For example, the white particles 152 may be particles having (+) charges, and the black particles 153 may be particles having (−) charges. For example, the white particles 152 may be TiO₂, PMMA, or the Ike, and the black particles 153 may be copper chromite, styrene, or the like. When an electric field is applied to the ink layer 150, the white particles 152 and the black particles 153 are moved in opposite directions.

As illustrated in FIG. 2, the ink layer 150 may include a plurality of microcapsule type ink cells 154 encapsulated with the electrophoretic liquid 151 and the white particles 152 and the black particles 153. Each of the ink cells 154 may form one pixel. Depending on the electric field applied to the ink layer 150, as the white particles 152 and the black particles 153 of each ink cell 154 are moved toward the support layer 130 or the surface layer 160 in the electrophoretic liquid 151, an image may be displayed.

As illustrated in FIG. 3, the ink layer 150 may include a plurality of cup-shaped ink cells 155 defined by partitions. Each of the plurality of ink cells 155 is filled with the electrophoretic liquid 151, the white particles 152, and the black particles 153. Each of the ink cells 155 may form one pixel. A sealing layer 180 may be between the ink layer 150 and the conductive layer 140. Depending on the electric field applied to the ink layer 150, as the white particles 152 and the black particles 153 of each ink cell 155 are moved toward the support layer 130 or the surface layer 160 in the electrophoretic liquid 151, an image may be displayed.

The white particles 152 and the black particles 153 do not move unless an electric field is applied to the ink layer 150. The image displayed on the ink layer 150 by the electric field once applied remains unchanged unless the electric field is applied again.

To display a three-color image, the electrophoretic liquid 151 may have a color. For example, the electrophoretic liquid 151 may have any one color of cyan, magenta, and yellow. The electric field applied to the ink layer 150 may include a first electric field displaying a white image, a second electric field displaying a black image, and a third electric field between the first electric field and the second electric field. When the first electric field is applied to a specific pixel of the ink layer 150, the white particles 152 are moved toward the surface layer 160, and a white image is observed through the surface layer 160. When the second electric field is applied to a specific pixel of the ink layer 150, the black particles 153 are moved toward the surface layer 160, and a black image is observed through the surface layer 160. When the third electric field is applied to a specific pixel of the ink layer 150, the white particles 152 and the black particles 153 are centrally located within, that is, are moved toward the center of, the pixel, and the electrophoretic liquid 151 is exposed toward the surface layer 160. Therefore, an image having the color of the electrophoretic liquid 151 is observed through the surface layer 160.

Referring to FIGS. 1 to 3, the electronic ink paper 100 may include an electrical contact 170, The electrical contact 170 is electrically connected to the conductive layer 140. The electrical contact 170 is for grounding the conductive layer 140. The electrical contact 170 may be electrically connected to the conductive layer 140 and may be provided at an appropriate location to be connected to an external grounding device. For example, the electrical contact 170 is provided on the support layer 130, the surface layer 160, or the border 120 to be electrically connected to the conductive layer 140 and exposed to the outside. In the present example, the electrical contact 170 is provided on the support layer 130 and penetrates the support layer 130 to be electrically connected to the conductive layer 140. The electrical contact 170 is exposed to the outside through the support layer 130.

When the electronic ink paper 100 is transferred in a longitudinal direction L in a printer to be described later below, the electrical contact 170 may be formed to extend in the longitudinal direction L, for example, in a portion of a width direction W as shown by dashed lines in FIG. 1. Although not shown in the drawings, in a printer to be described later below, when the electronic ink paper 100 is transferred in the width direction W, the electrical contact 170 may be formed to extend in the width direction W in a portion of the longitudinal direction L.

Although not shown in the drawing, the electrical contact 170 may be formed to have a certain length in the longitudinal direction L and the width direction W of the electronic ink paper 100. In this case, in the printer to be described later below, a grounding device may be formed to extend in a transfer direction of the electronic ink paper 100 such that the electronic ink paper 100 may be maintained in contact with the electrical contact 170 while being transferred.

When an image displayed on the image display area 110 of the electronic ink paper 100 is to be initialized, an initialization voltage may be applied to the surface layer 160. The initialization voltage may be, for example, a voltage that moves the white particles 152 toward the surface layer 160. Since the electrical contact 170 is connected to the grounding device, a potential of the conductive layer 140 becomes 0 V, and the black particles 153 having (−) charges are moved toward the conductive layer 140 and the white particles 152 having (+) charges are moved toward the surface layer 160. Therefore, a white image is displayed on the entire image display area 110 observed through the surface layer 160, so that the white image may be in the same state as plain paper before printing.

Since a conventional electrophoretic display requires a thin-film transistor array to drive an ink layer, it is difficult to manufacture the electrophoretic display in a flexible form. In addition, a transparent common electrode, which is expensive, is required. On the other hand, since the electronic ink paper 100 of the present example does not require a thin-film transistor array compared to the conventional electrophoretic display, the electronic ink paper 100 may be implemented in a flexible form like paper, and may be manufactured at low cost.

Unlike the conventional electrophoretic display, since the opaque conductive layer 140 including an inexpensive opaque conductive material instead of a higher-cost transparent electrode material may be applied to the electronic ink paper 100 of the present example, the electronic ink paper 100 of the present example may be manufactured at lower cost than the conventional electrophoretic display.

Since the image displayed on the ink layer 150 by an electric field once applied remains unchanged unless the electric field is applied again, the electronic ink paper 100 of the present example has image preservability. In addition, the image displayed on the ink layer 150 is maintained without a refresh process. Therefore, it is possible to reduce eye fatigue and burden when viewing the image.

Unlike paper, the electronic ink paper 100 of the present example may be reused many times. When a new image is to be displayed on the electronic ink paper 100 of the present example, an initialization voltage is applied to initialize the image display area 110. Thereafter, an electric field corresponding to image information to be displayed is applied to the ink layer 150 to display a new image on the image display area 110.

In a conventional printing apparatus, an image is printed by attaching toner, ink, or the like to a printing medium such as paper, and thus, paper and toner or ink prices are included in one printing cost. On the other hand, since the electronic ink paper 100 of the present example may repeatedly display an image without supply of toner and ink, the one printing cost may be much lower than the printing cost of using paper in some cases.

Therefore, the electronic ink paper 100 of the present example may be used as a printing medium by replacing conventional paper, and may reduce the amount of paper used and, therefore, contribute to environmental preservation.

As described above, according to the electronic ink paper 100 of the present example, after an image is displayed, the displayed image is maintained as long as no electric field is applied to the ink layer 150 from the outside of the electronic ink paper 100. That is, since the image is implemented by the movement of the particles 152 and 153 by the electric field applied to the ink layer 150, printing is performed using a printer that applies an electric field corresponding to image information to the electronic ink paper 100.

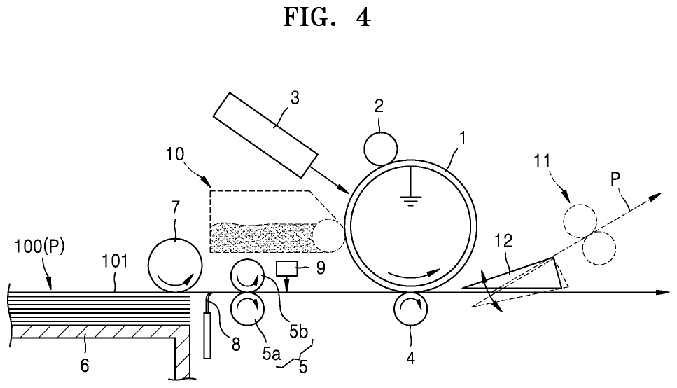

FIG. 4 is a schematic configuration diagram of an example of a printer using the electronic ink paper 100. The printer of the present example prints an image on the electronic ink paper 100 by an electrophotographic method.

FIG. 4 shows a photosensitive drum 1. The photosensitive drum 1 may include a conductive core and a photoconductive layer formed on an outer periphery of the conductive core. The photoconductive layer may be, for example, an organic photoconductive layer A charging roller 2 is an example of a charger that charges an outer peripheral surface of the photosensitive drum 1 with a uniform electric potential by supplying an electric charge to the outer peripheral surface of the photosensitive drum 1, The charging roller 2 is rotated in contact with the photosensitive drum 1. A charging bias voltage is applied to the charging roller 2, Instead of the charging roller 2, a charging brush, a corona charger, or the like may be employed.

An optical scanner 3 changes a surface potential of the photosensitive drum 1 by irradiating a surface of the photosensitive drum 1 with light modulated in response to image information. Thereby, an electrostatic latent image corresponding to the image information is formed on the surface of the photosensitive drum 1. For example, a laser scanning unit (LSU) may be employed as the optical scanner 3.

A transfer roller 4 is an example of a transfer member facing the photosensitive drum 1 to form a transfer nip through which the electronic ink paper 100 passes. A transfer voltage may be applied to the transfer roller 4. In the electronic ink paper 100, the surface layer 160 faces the photosensitive drum 1, While the electronic ink paper 100 passes through the transfer nip, the particles 152 and 153 in the ink layer 150 are moved toward the surface layer 160 or the support layer 130 by an electric field formed between the transfer roller 4 and the photosensitive drum 1 to display an image in the image display area 110. In the present example, the transfer roller 4 rotated as a transfer member is employed, but a flat plate-shaped transfer member forming a transfer nip between the photosensitive drum 1 may also be employed.

An initialization member 5 for initializing the image displayed on the electronic ink paper 100 is located at the entrance of the transfer nip. The initialization member 5 is a conductor. An initialization voltage is applied to the initialization member 5. The initialization member 5 may include, for example, a pair of rollers 5a and 5b that transport the electronic ink paper 100 while engaged with each other and rotated. An initialization voltage is applied to the pair of rollers 5a and 5b. Thereby, the image display area 110 of the electronic ink paper 100 is initialized, for example, as a whole to white. Instead of the pair of rollers 5a and 5b, a pair of flat plate members arranged to face each other may be employed.

Now, a printing process by the above-described configuration will be described.

The electronic ink paper 100 loaded on a loading table 6 is conveyed to the initialization member 5 by a pick-up roller 7. In the electronic ink paper 100, the surface layer 160 contacts the roller 5b and the support layer 130 contacts the roller 5a The roller 5a may be grounded. An initialization voltage of, for example, −10 V may be applied to the roller 5b. The roller 5a is in contact with the electrical contact 170, and a voltage of 0 V is applied to the conductive layer 140 electrically connected to the electrical contact 170. The white particles 152 having (+) charges are moved toward the surface layer 160, and the black particles 153 having (−) charges are moved toward the support layer 130. Therefore, the entire image display area 110 is initialized as a white image.

The charging roller 2 charges the surface of the photosensitive drum 1, for example, at about −500 V to 700 V. The photosensitive drum 3 irradiates light on the surface of the photosensitive drum 1. A potential of a portion irradiated with light of the surface of the photosensitive drum 1 is, for example, about −10 V to −50 V, and a potential of a portion not irradiated with light of the surface of the photosensitive drum 1 is maintained at about −500 V to 700 V. Thereby, an electrostatic latent image is formed on the surface of the photosensitive drum 1. In the present example, a portion that is not irradiated with light is a background portion, that is, a non-image portion.

The electronic ink paper 100 enters the transfer nip. In the transfer nip, the transfer roller 4 contacts the electrical contact 170. A transfer voltage of 0 V may be applied to the transfer roller 4. The transfer voltage may be, for example, 0 V. That is, the transfer roller 4 may be grounded. While the electronic ink paper 100 passes through the transfer nip, a voltage of 0 V is applied to the conductive layer 140 electrically connected to the electrical contact 170. While the electronic ink paper 100 passes through the transfer nip, black particles 153 having (−) charges are moved toward the surface layer 160 in the ink cell 154 facing an image portion of the photosensitive drum 1, and the particles 152 and 153 are not moved in the ink cell 154 facing the non-image portion of the photosensitive drum 1. When the electronic ink paper 100 passes through the transfer nip by such an operation, a black and white image is displayed on the image display area 110 of the electronic ink paper 100.

The printer illustrated in FIG. 4 may further include a configuration for printing an image on a printing medium P, such as paper, by an electrophotographic method. For example, a developing device 10 for supplying toner to the surface of the photosensitive drum 1 between the optical scanner 3 and the transfer roller 4 to develop an electrostatic latent image into a visible toner image may be provided. Since the structure of the developing device 10 is well-known to one of ordinary skill in the art, a detailed description thereof will not be given herein. To transfer a toner image to the printing medium P, a bias voltage having a polarity opposite to that of the toner image may be applied to the transfer roller 4. The printing medium P may be loaded on the loading table 6. The printing medium P is picked up by the pick-up roller 7 and conveyed to the transfer nip. While the printing medium P passes through the transfer nip, a toner image formed on the photosensitive drum 1 is transferred to the printing medium P. The printing medium P that has passed through the transfer nip is conveyed to a fixing device 11. While the printing medium P passes through the fixing device 11, the toner image is fixed to the printing medium P by heat and pressure.

The electronic ink paper 100 should not pass through the fixing device 11. To this end, a path selection member 12 may be at the exit of the transfer nip. When printing is performed on the electronic ink paper 100, the path selection member 12 is located at a first guide position for guiding the electronic ink paper 100 that has passed through the transfer nip to be discharged from the printer without passing through the fixing device 11 as shown by solid lines in FIG. 4. When printing is performed on the printing medium P, the path selection member 12 is located at a second guide position for guiding the printing medium P that has passed through the transfer nip to the fixing device 11 as shown by dashed lines in FIG. 4. For example, the path selection member 12 may be switched between the first guide position and the second guide position by an actuator such as a solenoid (not shown).

The pick-up roller 7 picks up one sheet of electronic ink paper 101 at the top of a plurality of sheets of electronic ink paper 100 loaded on the loading table 6. While the sheet of electronic ink paper 101 is withdrawn, static electricity may be generated by friction with the electronic ink paper 100 therebelow. Since static electricity brings the sheets of electronic ink paper 100 into close contact with each other, defective pick-up or double feeding may occur if the static electricity is not removed. Defective pick-up means that the electronic ink paper 100 is not fed despite the rotation of the pick-up roller 7. Double feeding means that two or more sheets of electronic ink paper 100 are attached and fed together. In view of this, the printer may further include a static eliminator 8 that removes static electricity from the electronic ink paper 100. The static eliminator 8 may be grounded. The static eliminator 8 may be implemented by, for example, a conductive brush, a conductive roller, or the like that comes into contact with the sheet of electronic ink paper 101 drawn out from the loading table 6. By including the static eliminator 8, defective pick-up or double feeding due to static electricity may be reduced.

The electronic ink paper 100 should not be easily bent or folded during use. To this end, flexibility of the electronic ink paper 100 may be 1 GPa or more, and tenacity of the electronic ink paper 100 may be 83 MPa or more. Visibility of the electronic ink paper 100 depends on optical properties of the surface layer 160. To ensure the visibility of the electronic ink paper 100, a refractive index of the surface layer 160 may be 1.7 or less, and the birefringence of the surface layer 160 may be 13 nm or more. Image distortion, such as image overlapping, may occur when viewing an image displayed on the ink layer 150 from the surface layer 160 side when the refractive index of the surface layer 160 is more than 1.7 and the birefringence of the surface layer 160 is less than 13 nm. In addition, image information may be distorted when an image displayed on the electronic ink paper 100 is scanned using a scanner.

The electronic ink paper 100 may be reused several times. Therefore, the edge of the electronic ink paper 100 may be damaged during the process of handling the electronic ink paper 100 and during several times of printing. In addition, the edge of the electronic ink paper 100 may be damaged by being jammed or the like in the printing process. In this regard, as shown in FIGS. 1 to 3, the electronic ink paper 100 includes the border 120 surrounding the edge of the image display area 110. The border 120 prevents damage to the image display area 110. The border 120 may be formed of an elastic body to withstand bumping or friction. The edge 120 may be connected to at least one of the surface layer 160 and the support layer 130. For example, the border 120 may include silicone rubber. The border 120 may be attached to the edge of the image display area 110. With this configuration, damage to the image display area 110 may be prevented, and a reduction in life due to physical damage to the electronic ink paper 100 may be prevented.

Referring to FIGS. 2 and 3, at least one edge of the border 120 may be a tapered shape that decreases in thickness toward the outside. The border 120 includes two edges 121 and 122 in the longitudinal direction L of the electronic ink paper 100 and two edges 123 and 124 in the width direction W. The tapered shape is provided on at least one of the four edges 121-124. The electronic ink paper 100 may be transported in the longitudinal direction L in the printer. In this regard, the two edges 121 and 122 in the longitudinal direction L may be tapered. The electronic ink paper 100 may be transferred in the width direction Win the printer. In this regard, the two edges 123 and 124 in the width direction W may also be tapered.

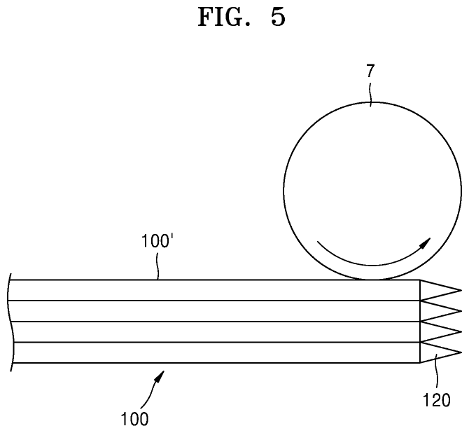

FIG. 5 shows a state in which plural pieces of electric ink paper 100 are loaded on the loading table 6 in an example. Referring to FIG. 5, the pick-up roller 7 is in contact with electronic ink paper 100′ located at the top of the plural pieces of electric ink paper 100. When the pick-up roller 7 is rotated, the electronic ink paper 100′ is separated and transferred. At this time, front ends of the plural pieces of electronic ink paper 100 are separated from each other by the tapered border 120. Therefore, it is possible to reduce the possibility of double feeding in which two or more pieces of electronic ink paper 100 are picked up and fed together among the plural pieces of electronic ink paper 100 on the loading table 6. In addition, the electronic ink paper 100 enters between nips formed by rollers 5a and 5b which are engaged with each other. At this time, the tapered border 120 is more easily inserted between the nips than a non-tapered border. Therefore, in the process of conveying the electronic ink paper 100, the possibility of the occurrence of a jam may be reduced. In addition, the tapered border 120 is easier to pick up the electronic ink paper 100 than the non-tapered border, thereby reducing the possibility of damage in the process of handling the electronic ink paper 100.

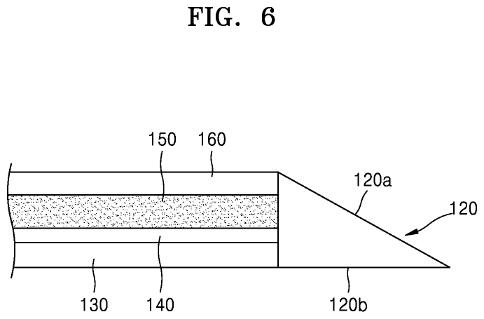

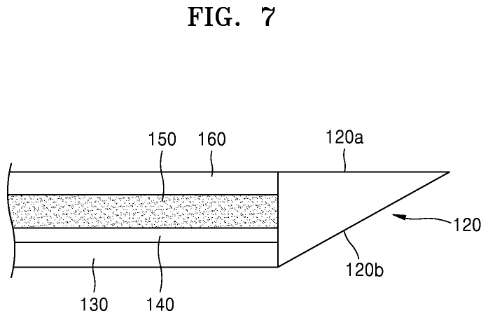

In FIGS. 2 and 3, the border 120 is a tapered shape in which two sides extend outwardly to incline downward and upward from the surface layer 160 and the support layer 130, respectively, but the tapered shape of the border 120 is not limited thereto. FIGS. 6 and 7 show various examples of the tapered shape of the border 120. Referring to FIG. 6, a side 120b of the border 120 extends outwardly from the support layer 130 in parallel with the support layer 130, and a side 120a extends outwardly to incline downward from the surface layer 160. Referring to FIG. 7, the side 120a of the border 120 extends outwardly from the surface layer 160 in parallel with the surface layer 160, and the side 120b extends outwardly to incline upward from the support layer 130.

The border 120 may be formed by being supported by one of the support layer 130 and the surface layer 160, and may surround the ink layer 150 and the other of the support layer 130 and the surface layer 160. Even in this case, the edge of the border 120 may have a tapered shape that decreases in thickness toward the outside of the border 120.

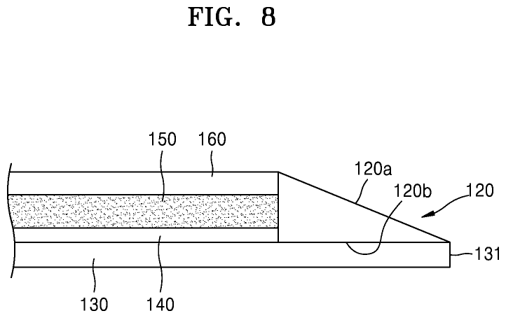

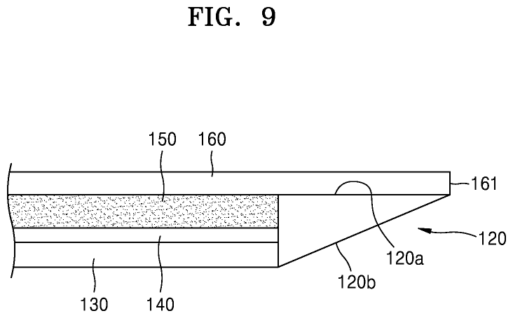

FIGS. 8 and 9 are views showing various examples of the border 120. First, referring to FIG. 8, the border 120 is formed on the support layer 130. The side 120a of the border 120 extends outwardly to incline downward from the surface layer 160 to an end 131 of the support layer 130, and the side 120b is supported by the support layer 130. Referring to FIG. 9, the border 120 is formed on the surface layer 160. The side 120b of the border 120 extends outwardly to incline upward from the support layer 130 to extend to an end 161 of the surface layer 160, and the side 120a is supported on the surface layer 160.

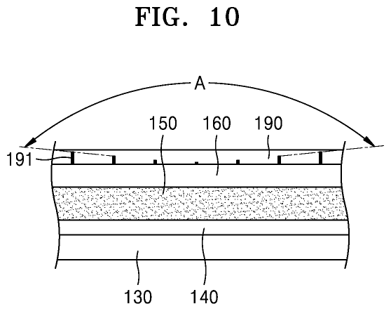

FIG. 10 is a plan view of one example of the electronic ink paper 100. Referring to FIG. 10, the electronic ink paper 100 may be provided on the surface layer 160 to include a polarizing layer 190 that limits a viewing angle. The polarizing layer 190 may be formed such that light of specific polarization may pass through, and may be formed to pass light having a specific incident angle range, thereby limiting a viewing angle. The polarizing layer 190 determines a viewing angle using birefringence or polarization. As an example, the polarizing layer 190 may be implemented by stacking two or more transparent material layers, at least one of which having a different refractive index, or by stacking two or more transparent material layers, at least one of which having a different polarization property. For example, the polarizing layer 190 may have a form in which a PET layer and a polyethylene naphthalate (PEN) layer are stacked. As another example, the polarizing layer 190 may have a structure in which any one material layer of a PET layer, a PP layer, and a PE layer and a polyvinyl alcohol (PVA) layer are stacked. As an example, the polarizing layer 190 may be implemented by etching inside a transparent polymer material layer such as a PET layer, a PP layer, or a PE layer to form slits having an angle, and then applying iodine and a dye, which are dichroic materials, to have polarization. In addition, as illustrated in FIG. 10, the polarizing layer 190 may be implemented in a form in which a plurality of nano-sized blinders 191 are formed inside the transparent polymer material layer. A viewing angle A may be limited by the plurality of nano-sized blinders 191.

Since light of a specific polarization may pass through the polarizing layer 190, the image formed in the image display area 110 may be viewed under illumination irradiating light having a specific polarization. The electronic ink paper 100 of this type may be utilized as security printing paper. In addition, a viewing angle may be limited by forming the polarizing layer 190 to pass light incident in a specific angle range using the nano-sized blinders 191.

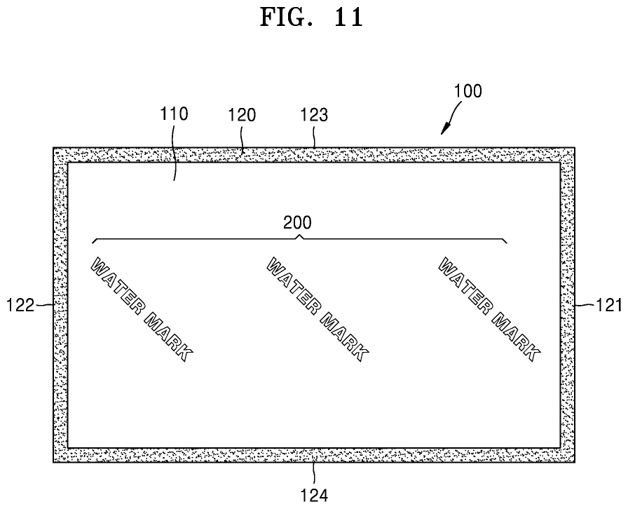

FIG. 11 is a plan view of one example of the electronic ink paper 100. Referring to FIG. 11, the electronic ink paper 100 may further include a water mark 200. The water mark 200 may be provided on, for example, the surface layer 160. The water mark 200 may be formed on the surface layer 160 in an uneven shape. The water mark 200 may be formed by printing the surface layer 160 using translucent ink. The water mark 200 may have various shapes. The water mark 200 may be formed in various forms, such as a letter, a pattern, and gradation, indicating a company, a department of the company, and the like. The water mark 200 may be applied, for example, for document security.

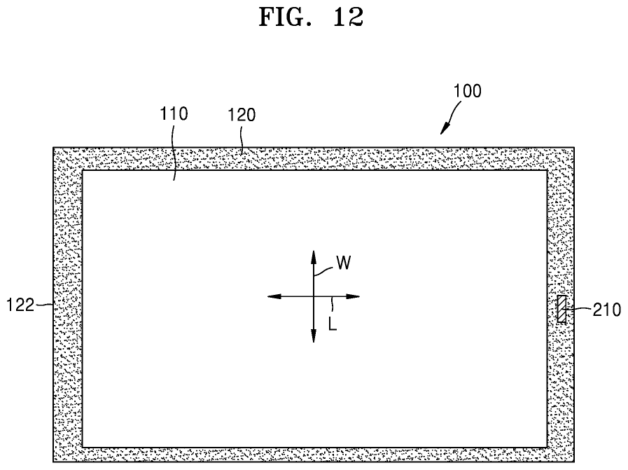

FIG. 12 is a plan view of one example of the electronic ink paper 100. Referring to FIG. 12, the electronic ink paper 100 may include a detectable identification unit 210 for identification of the electronic ink paper 100. The identification unit 210 may be provided at a position that may be detected by a detector 9 provided in a printer as shown in FIG. 4 while the electronic ink paper 100 is being conveyed in the printer. For example, the identification unit 210 may be provided on the border 120 or may be provided on the image display area 110. As illustrated in FIG. 12, the identification unit 210 may be provided near one end of the electronic ink paper 100 in the longitudinal direction L. Although not shown in the drawings, the identification unit 210 may be provided near both ends of the electronic ink paper 100 in the longitudinal direction L. Although not shown in the drawings, the identification unit 210 may be provided near one end or near both ends of the electronic ink paper 100 in the width direction W.

The identification unit 210 may be formed to be detected by, for example, an electrical, magnetic, or optical detection device. For example, the identification unit 210 may be implemented in the form of a barcode form, a QR code form, a conductor pattern, a magnetic material pattern, or an electronic circuit such as a memory chip or a security chip connected to the detector 9 by wire or wireless while the electronic ink paper 100 is transported in the printer. The identification unit 210 may display identification information of the electronic ink paper 100. The identification information may include, for example, paper information such as a serial number and paper size, security information, and the like. The detector 9 of the printer may detect the identification unit 210 while the electronic ink paper 100 is being conveyed. The detected identification information may be transmitted to, for example, a server via the printer. The printer may track the number of times the electronic ink paper 100 is used from the detected identification information. The printer may identify whether the electronic ink paper 100 is security paper or the like from the detected identification information, and may continue or stop a print job depending on whether the paper is security paper. The printer may identify whether the electronic ink paper 100 is suitable for electrophoretic printing from the detected identification information, and may continue or stop a print job depending on whether the paper is suitable. In addition, the identification information may be used for billing for paying users.

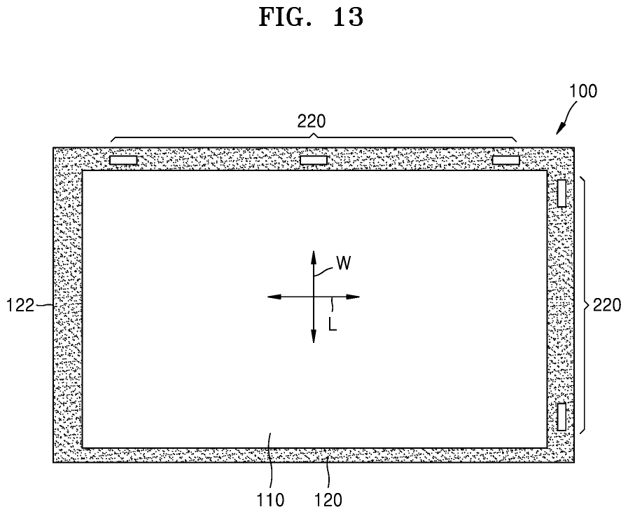

FIG. 13 is a plan view of one example of the electronic ink paper 100. Referring to FIG. 13, the electronic ink paper 100 may include at least one hole 220. The hole 220 may be provided on the border 120. The hole 220 may be used to bind plural pieces of electronic ink paper 100. As shown in FIG. 13, the hole 220 may be provided near one end of the electronic ink paper 100 in the longitudinal direction L and near one end of the electronic ink paper 100 in the width direction W. Although not shown in the drawings, the hole 220 may be provided at the corner of the electronic ink paper 100.

It should be understood that examples described herein should be considered in a descriptive sense only and not for purposes of limitation. Descriptions of features or aspects within each example should typically be considered as available for other similar features or aspects in other examples. While one or more examples have been described with reference to the figures, it will be understood by those of ordinary skill in the art that various changes in form and details may be made therein without departing from the spirit and scope as defined by the following claims.

What is claimed is:

1. Electronic ink paper comprising:
an image display area comprising a support layer, a conductive layer on the support layer, an ink layer on the conductive layer and to display an image by electrophoresis of pigment particles in an electrophoretic liquid based on at least one electric field applied to the ink layer, and a transparent surface layer to cover the ink layer; and
a border to surround the image display area and including at least one edge having a tapered shape that decreases in thickness toward the outside of the border.

2. The electronic ink paper of claim 1, wherein the border includes an elastic body.

3. The electronic ink paper of claim 1, wherein the border includes one or more holes.

4. The electronic ink paper of claim 1, wherein the conductive layer includes an opaque conductive material.

5. The electronic ink paper of claim 1, wherein the electrophoretic liquid includes a color.

6. The electronic ink paper of claim 1, wherein flexibility is at least 1 Gpa, and tenacity is at least 83 Mpa.

7. The electronic ink paper of claim 1, wherein a refractive index of the surface layer is about 1.7 or less, and birefringence of the surface layer is 13 nm or more.

8. The electronic ink paper of claim 1, further comprising an electrical contact electrically connected to the conductive layer to ground the conductive layer.

9. The electronic ink paper of claim 1, wherein a water mark is formed on at least one of the support layer and the surface layer.

10. The electronic ink paper of claim 1, further comprising a detectable identification unit to identify the Electronic ink paper.

11. The electronic ink paper of claim 1, wherein the surface layer includes a polarizing layer to limit a viewing angle.

12. Electronic ink paper comprising:
an image display area comprising a support layer, a conductive layer on the support layer, an ink layer on the conductive layer and to display an image by electrophoresis of pigment particles dispersed in an electrophoretic liquid based on at least one electric field applied to the ink layer, and a transparent surface layer to cover the ink layer;
an electrical contact electrically connected to the conductive layer to ground the conductive layer; and
a border to surround the image display area.

13. The electronic ink paper of claim 12, wherein the border includes an elastic body to connect to at least one of the surface layer and the support layer.

14. The electronic ink paper of claim 13, wherein at least one edge of the border having a tapered shape that decreases in thickness toward the outside of the border.

15. The electronic ink paper of claim 14, further comprising a detectable identification unit to identify the electronic ink paper.
